(19) United States
(12) Patent Application Publication
(10) Pub. No.: US 2010/0175368 A1
(43) Pub. Date: Jul. 15, 2010

(54) METHOD FOR CHECKING AN OXIDATION CATALYTIC CONVERTER AND EXHAUST GAS AFTER TREATMENT ARRANGEMENT FOR AN INTERNAL COMBUSTION ENGINE

(75) Inventor: Andreas Schulze, Stuttgart (DE)

Correspondence Address: MERCHANT & GOULD PC, P.O. BOX 2903, MINNEAPOLIS, MN, 55402-0903, US

(73) Assignee: Robert Bosch GMBH, Stuttgart (DE)

(21) Appl. No.: 12/685,943

(22) Filed: Jan. 12, 2010

(30) Foreign Application Priority Data
Jan. 12, 2009 (DE) 10 2009 000 148.4

(51) Int. Cl. F01N 11/00; G01M 15/04

(52) U.S. Cl. 60/273; 60/276; 73/114.75

(57) ABSTRACT

The invention relates to a method (71) for checking the operability of an oxidation catalytic converter (29), through which exhaust gas (43, 49) of an internal combustion engine (11) flows, wherein a first sensor variable (x₁, y₁), which characterizes a composition of the exhaust gas (43) flowing into the oxidation catalytic converter (29), and a second sensor variable (x₂, y₂), which characterizes a composition of the exhaust gas (49) flowing out of the oxidation catalytic converter (29), are acquired. In order to state a method (71) for checking the operability of an oxidation catalytic converter (29), with which the operability of the oxidation catalytic converter (29) can be more accurately and reliably ascertained, it is proposed that the first sensor variable (x₁, y₁) be acquired by means of a first mixed potential sensor (45, 47) disposed in a direction of flow of the exhaust gas upstream of the oxidation catalytic converter and the second sensor variable (x₂, y₂) be acquired by means of a second mixed potential sensor (51, 53) disposed in the direction of flow of the exhaust gas downstream of the oxidation catalytic converter (29) and that the operability of the oxidation catalytic converter (29) be ascertained by comparing (92) the first sensor variable (x₁, y₁) with the second sensor variable (x₂, y₂).

This application claims benefit of Serial No. 10 2009 000 148.4, filed 12 Jan. 2009 in Germany and which application is incorporated herein by reference. To the extent appropriate, a claim of priority is made to the above disclosed application.

### BACKGROUND

The invention relates to a method for checking the operability of an oxidation catalytic converter, through which exhaust gases of an internal combustion engine flow.

A method for detecting damage to a NOₓ storage catalytic converter is known from the German patent application DE 199 26 149 A1. When executing this method, a course of the concentration of at least one gas component is acquired with the aid of a gas sensor during and after the change of a mode of operation of an internal combustion engine. The course is then compared with a nominal course. If the acquired course deviates from the nominal course, the NOₓ catalytic converter is then deemed to be damaged.

This method is based on the fact that the concentration of the gas component acquired downstream of the storage catalytic converter does not precipitously react to the change in the mode of operation but reacts with a continually changing course of the exhaust gas component. This continuous course is caused by storage effects within the storage catalytic converter. The known method can also be used in a corresponding fashion to check a 3-way catalytic converter. This is the case because a defective 3-way catalytic converter has a relatively low oxygen storage capacity in contrast to a fully operative 3-way catalytic converter and because the oxygen storage capacity of the three-way catalytic converter can, for example, be checked with a lambda probe.

In contrast to storage catalytic converters and three-way catalytic converters, oxidation catalytic converters do not however exhibit any substantial storage effects so that a check of the operability of oxidation catalytic converters on the basis of their storage capacity, respectively by evaluating an acquired course of the concentration of the gas component, can not be effectively implemented.

A known check of the operability of an oxidation catalytic converter is possible by virtue of the fact that a reaction heat, which is released as a result of chemical reactions with the oxidation catalytic converter, is acquired and the oxidation catalytic converter is deemed to be damaged if a temperature rise in the exhaust gas streaming through the oxidation catalytic converter, which is caused by the reaction heat, is too small. This method is based on the fact that the number of active centers within the oxidation catalytic converter decreases with ageing within the oxidation catalytic converter, and the chemical reactions consequently occur to a lesser extent. A disadvantage of this method is that only an indirect correlation exists between the temperature rise in the exhaust gas and the operability of the oxidation catalytic converter so that the method ascertains the operability with a relatively low degree of accuracy. The danger therefore arises that an efficient oxidation catalytic converter is falsely recognized to be defective or that a defective oxidation catalytic converter is falsely recognized to be in working order.

The world patent application WO 01/23730 A2 displays a method for operating a mixed potential sensor, wherein a high selectivity with respect to individual components of the exhaust gas, to which the mixed potential sensor is exposed, is made possible by an appropriate activation of the mixed potential sensor.

### SUMMARY

The aim of the invention is to state a method for checking the operability of an oxidation catalytic converter, with which the operability of the oxidation catalytic converter can be ascertained more accurately and more reliably.

The invention is based on the knowledge that the temporal course of a variable acquired with the aid of a gas sensor does not allow for a reliable check of the operability of the oxidation catalytic converter on account of the storage effects being difficult to measure and at best insignificant in the case of an oxidation catalytic converter. The invention is furthermore based on the knowledge that mixed potential sensors allow for an acquisition of concentrations of exhaust gas components, which are relevant to a check of the operability of the oxidation catalytic converter. In the process, instant values of the two sensor variables, which have been acquired by the first mixed potential sensor and the second mixed potential sensor, have to be compared with each other. In so doing, at least one instant value of the first sensor variable and/or at least one instant value of the second sensor variable are preferably acquired.

The oxidation catalytic converter can by and large be monitored with respect to its operability and its ageing condition when implementing the method according to the invention, and if need be the operability, respectively inoperability, of the oxidation catalytic converter can be recognized. Conversely a temperature of the oxidation catalytic converter can be estimated, for example, using a model for the oxidation catalytic when the ageing condition is known as a function of the sensor signals.

Different types of mixed potential sensors can be employed. It is, however, preferred that the first mixed potential sensor and/or the second mixed potential sensor relate to a sensor for the hydrocarbons contained in the exhaust gas. It is thus preferred with respect to the facets of the method that the first sensor variable characterizes a concentration of hydrocarbons contained in the hydrocarbons in the exhaust gas upstream of the catalytic converter, and the second sensor variable characterizes a concentration of hydrocarbons contained in the hydrocarbons in the exhaust gas exiting downstream of the catalytic converter.

In so doing, it is preferred that a first variable is ascertained, which characterizes a reaction rate of an oxidation of the hydrocarbons taking place in the catalytic converter, when comparing the two sensor variables with each other and that the oxidation catalytic converter is recognized to be in working order if the variable lies in a predetermined first range, preferably if the first variable is at least as large as a predetermined first threshold value, which constitutes the lower limit of a range which is open to the top. A check is thereby made to determine whether a sufficiently large conversion of the hydrocarbons takes place in the oxidation catalytic converter. Should the first variable lie outside of the predetermined range or should it be smaller than the first threshold value, the oxidation catalytic converter is than deemed to be inoperative.

In addition to or as an alternative to this, it is preferred that the first sensor variable should characterize a concentration of nitrogen dioxide, a concentration of nitrogen oxides or a percentage of the nitrogen dioxide to the nitrogen oxides in the exhaust gas upstream of the oxidation catalytic converter and/or that the second sensor variable should characterize a concentration of nitrogen dioxide, a concentration of nitrogen oxides or a percentage of the nitrogen dioxide to the nitrogen oxides in the exhaust gas downstream of the oxidation catalytic converter. For this purpose, a check is made to determine whether the catalytic converter is still sufficiently capable of supporting an oxidation of nitrogen monoxide to nitrogen dioxide or if said converter has already too extensively lost this function. The first and/or the second mixed potential sensor can accordingly be configured as nitrogen oxide sensors.

In this connection, it is preferred that a second variable, which characterizes a change in the percentage of the nitrogen dioxide to the nitrogen oxides, is ascertained when the two variables are compared with each other. Said change occurs as a result of chemical reactions in the oxidation catalytic converter. It is also preferred that the oxidation catalytic converter is recognized to be in working order, if the second variable lies within a predetermined range. The oxidation catalytic converter is preferably then recognized to be in working order if the second variable is at least as large as a predetermined second threshold value. The second variable therefore characterizes the change in a ratio between the content of nitrogen dioxide and the content of nitrogen oxides in the exhaust gas. An operative oxidation catalytic converter causes this ratio to increase and to approach a chemical equilibrium value which is dependent on the temperature of the exhaust gas.

Provision is made in a preferred embodiment of the invention for the first mixed potential sensor and/or the second mixed potential sensor to be activated for influencing a sensitivity of the same with respect to the hydrocarbons, the nitrogen dioxide, the nitrogen oxides and/or the percentage of the nitrogen dioxide to the nitrogen oxides. This activation allows for a successive, i.e. sequential, acquisition of the concentrations of the aforementioned components of the exhaust gas. By way of derogation, provision can, however, be made in each case for a plurality of mixed potential sensors, whose sensitivities vary with respect to the components of the exhaust gas, situated upstream of the oxidation catalytic converter and/or downstream of the oxidation catalytic converter. If, for example, a plurality of first mixed potential sensors is provided, the individual components of the exhaust gas flowing into the oxidation catalytic converter can be ascertained by evaluating the individual sensor signals. In an analogical fashion, a plurality of second mixed potential sensors can also be provided, and the components of the exhaust gas can simultaneously be analyzed. Instead of a plurality of mixed potential sensors, provision can also be made for a single mixed potential sensor with a plurality of sensor elements, which have different sensitivities with respect to the hydrocarbons and/or the nitrogen dioxide and/or the nitrogen oxides and/or with respect to the percentage of the nitrogen dioxide to the nitrogen oxides.

It is also preferred that an exhaust gas temperature of the exhaust gas flowing into the oxidation catalytic converter and/or of the exhaust gas flowing out of oxidation catalytic converter is ascertained or acquired and that the operability of the oxidation catalytic converter is checked as a function of the exhaust gas temperature. The accuracy and reliability of the method are further improved by taking into account the exhaust gas temperature when checking the operability of said catalytic converter. If the oxidation catalytic converter is operated with a relatively low exhaust gas temperature, which in particular is lower than a light-off-temperature of said converter, this will especially avoid the oxidation catalytic converter being deemed as inoperative. A temperature sensor disposed upstream or downstream of the oxidation catalytic converter can be used for acquiring the exhaust gas temperature. An empirical and/or physical model, which ascertains the exhaust gas temperature from state variables of the internal combustion engine, in particular one in a combustion process taking place in a combustion chamber of the internal combustion engine, can be employed for ascertaining the exhaust gas temperature.

It is preferred that the first range, respectively the first threshold value, and/or the second range, respectively the second threshold value, are predetermined as a function of the exhaust gas temperature.

The advantages of the method according to the invention are then especially achieved if the control unit is implemented with the characteristics of claim 9 for the open-loop and or closed-loop control of the internal combustion engine.

In so doing, it is preferred that the control unit for the internal combustion engine is equipped for executing the method according to the invention. The control unit can be fitted with a programmable computer with a program memory, which is programmed for executing the method according the invention.

The first mixed potential sensor and/or the second mixed potential sensor of the exhaust gas after-treatment arrangement can be configured as a sensor for hydrocarbons and/or as a sensor for nitrogen oxides.

### BRIEF DESCRIPTION OF THE DRAWINGS

Additional characteristics and advantages become apparent in the following description, wherein exemplary embodiments of the invention are explained in detail with the aid of the drawing. The following are thereby shown:

FIG. 1 is a schematic depiction of an internal combustion engine;

FIG. 2 is a flow diagram of a method for checking an oxidation catalytic converter of the internal combustion engine from FIG. 1 according to a first embodiment;

FIG. 3 is a diagram of a correlation between a temperature of the oxidation catalytic converter and a conversion of hydrocarbons;

FIG. 4 is a flow diagram of a method for checking the oxidation catalytic converter according to a second embodiment;

FIG. 5 is a diagram of a correlation between a temperature of the oxidation catalytic converter and a percentage of nitrogen dioxide in the exhaust gas.

### DETAILED DESCRIPTION

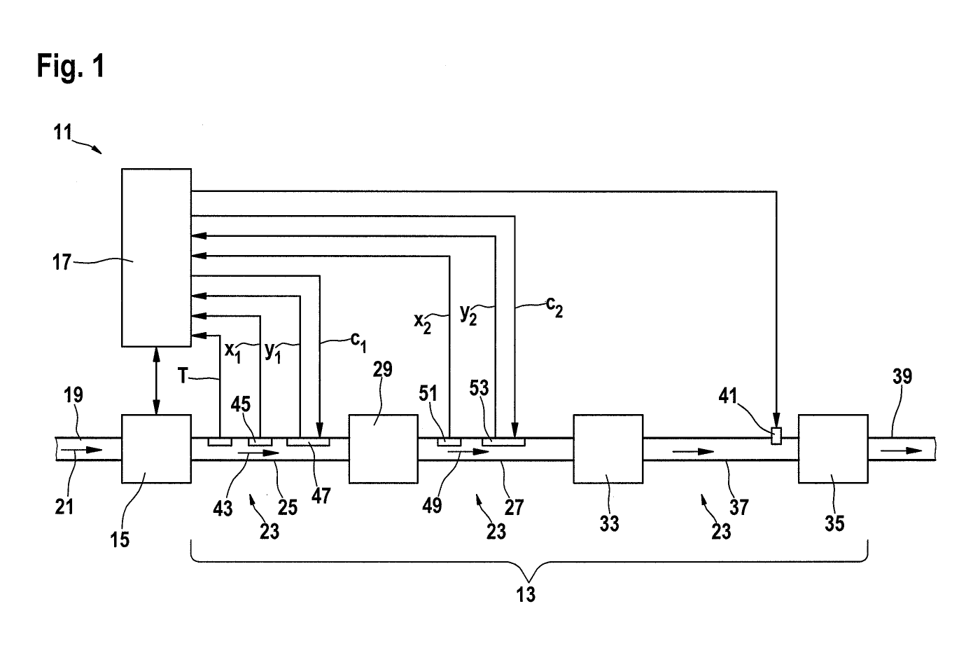

FIG. 1 shows an internal combustion engine 11 with an exhaust gas after-treatment arrangement 13. The internal combustion engine 11 has an engine block 15 with actuators and/or sensors, which are connected to an open-loop and/or closed-loop control device of the internal combustion engine 11, which is configured as a control unit 17. An intake manifold 19 for drawing in air (arrow 21) into the combustion chambers (not shown) of the engine block 15 is arranged on the engine block 15. Depending on the exact embodiment of the internal combustion engine 11, different parts of an air system of the internal combustion engine, which is unspecified in FIG. 1, can be disposed in the intake manifold 19. The air system can be fitted with sensors for acquiring various state variables of the air 21 as, for example, an air mass flow, an air temperature and/or an air pressure. Provision can furthermore be made in the air system for a throttling device for influencing the air mass flow. A compressor for the air system can additionally be disposed in the intake manifold for the purpose of compressing the air 21 being supplied to the engine block 15. In so doing, the compressor can in turn constitute a part of an exhaust gas turbocharger.

The internal combustion engine 11 is furthermore fitted with an exhaust pipe 23, a first section 25 of the exhaust pipe 23 being connected to the engine block 15 for withdrawing an exhaust gas situated in the combustion chambers of the engine block 15. An oxidation catalytic converter 29 of the exhaust gas after-treatment arrangement 13 is disposed between the first section 25 and a second section 27 of the exhaust pipe 23. An outlet of the oxidation catalytic converter 29 is connected to an inlet of a particle filter 33 of the exhaust gas after-treatment arrangement 13 via the second section 27 of the exhaust pipe 23. In addition the exhaust gas after-treatment arrangement 13 is fitted with a SCR catalytic converter 35, i.e. a catalytic converter for carrying out a selective catalytic reaction (SCR). The SCR catalytic converter is connected on the inlet side to an outlet of the particle filter 33 via a third section 37 of the exhaust pipe 23. A fourth section 39 of the exhaust gas pipe 23 is situated at the outlet of the SCR catalytic converter 35. An injection valve 41 controlled by the control unit 17 projects into the third section 37 of the exhaust pipe 23 for the purpose of injecting a diluted urea solution into said section 37. An actuator of the injection valve 41 is connected to an output of the control unit 17.

First mixed potential sensors for analyzing the exhaust gas flowing into the oxidation catalytic converter 29 (arrow 43) are disposed at the first section 25 of the exhaust pipe 23. The first sensors comprise a mixed potential sensor, which primarily is sensitive with respect to hydrocarbons and is denoted below in short as first HC sensor 45. The HC sensor 45 transmits a sensor variable x₁, which characterizes a concentration of hydrocarbons in the inflowing exhaust gas 43, to an input of the control unit 17. The first mixed potential sensors additionally comprise a first switchable mixed potential sensor 47, which can be switched between a first operating mode for acquiring a concentration of nitrogen dioxide (NO₂) in the inflowing exhaust gas 43 and a second operating mode for acquiring a concentration of nitrogen monoxide (NO) in the inflowing exhaust gas 43 by means of a first control signal c₁. The components NO₂ and NO can be separately detected one after another by means of the first switchable mixed potential sensor 47. A control input of the first switchable mixed potential sensor 47 used for applying the first control signal c₁ is connected to an output of the control unit 17. A measuring output of the first mixed potential sensor 47 for outputting an additional sensor variable y₁ is connected to an input of the control unit 17. By way of derogation, a mixed potential sensor, which can simultaneously detect the two components NO₂ and NO, can also be employed instead of the switchable first mixed potential sensor 47. Such a mixed potential sensor can, for example, be fitted with two sensor elements, which in each case are configured for detecting NO₂ and NO.

The second section 27 of the exhaust pipe 23 is fitted with second mixed potential sensors for analyzing exhaust gas flowing out of the oxidation catalytic converter 29 (arrow 49). The second sensors comprise a mixed potential sensor, which is sensitive to hydrocarbons contained in the outflowing exhaust gas 49 and is denoted below in short as second HC sensor 51. An output of the second HC sensor 51 for outputting an additional sensor variable x₂, which characterizes a concentration of hydrocarbons in the outflowing exhaust gas 49, is connected to a corresponding input of the control unit 17. In addition the second sensors comprise a second switchable mixed potential sensor 53, which has the same configuration as the first switchable mixed potential sensor 47 and can therefore selectively acquire a concentration of NO₂ or a concentration of NO in the outflowing exhaust gas 49. An input for feeding a second control signal c₂ used to switch between both operating modes of the second switchable mixed potential sensor 53 is connected to the output of the control unit 17. An output of the second switchable mixed potential sensor 53 for outputting a sensor variable y₂, which characterizes the concentration of NO₂, respectively NO, is connected to an input of the control unit 17. The two switchable mixed potential sensors 47, 53 can be operated with a method similar to the method described in the world patent application WO 01/23730 A2.

In addition to the first mixed potential sensors 45, 47 and the second mixed potential sensors 51, 53, the exhaust gas after-treatment arrangement 13 is fitted with a temperature sensor 55, which acquires a temperature T of the exhaust gas 43 flowing into the oxidation catalytic converter 29, in the first section 25 of the exhaust pipe 23. An output of the temperature sensor 55 for outputting an additional sensor variable, which characterizes the exhaust gas temperature T, is connected to an input of the control unit 17. In a non-depicted embodiment, the temperature sensor 55 is not present.

Deviating from the embodiment shown, the first mixed potential sensors 45, 47 and/or the second mixed potential sensors 51, 53 can also be constituted by another sensor configuration. Discrete mixed potential sensors for the hydrocarbons and the NO₂ and NO percentages of the nitrogen oxides in the exhaust gas can, for example, be present so that three mixed potential sensors are in each case present in the first section 25 and in the second section 27. It is also conceivable that at least one of the switchable mixed potential sensors 47, 53 can be switched in such a way that it can detect either the hydrocarbons or the nitrogen oxides. In addition provision can be made for the first section 25 as a mixed potential sensor only to be fitted with the first HC sensor 45, and the second section 27 as a mixed potential sensor only to be fitted with the second HC sensor 51. Conversely provision can be made for only the two switchable mixed potential sensors 47, 53 to be mixed potential sensors and the two HC sensors 45, 51 are omitted. In this case, only an analysis of the nitrogen oxides is possible.

Beyond that mentioned above, the configuration of the exhaust gas after-treatment arrangement 13 can be varied. A NOₓ storage catalytic converter can, for example, be disposed at a suitable position in the exhaust pipe 23. Particularly in this instance, the SCR catalytic converter 35 can be omitted.

During the operation of the internal combustion engine 11, its exhaust gas flows into the oxidation catalytic converter 29. In particular unburned hydrocarbons (HC) and/or carbon monoxide (CO) are converted there by oxidation to CO₂ and water. The exhaust gas 49 flowing out of the oxidation catalytic converter 29 moves into the second section 27 of the exhaust pipe 23 and from there into the particle filter 33, which removes particles present in the exhaust gas. The exhaust gas leaves the particle filter 33 and flows into the third section 37 of the exhaust pipe 23. A diluted urea solution is added there to the exhaust gas by means of the injection valve 41, before it moves into the SCR catalytic converter 35. The SCR catalytic converter 35 reduces nitrogen oxides contained in the exhaust gas 49 downstream of the oxidation catalytic converter 29. Finally the treated exhaust gas leaves the exhaust gas after-treatment arrangement 13 via the fourth section 39 of the exhaust pipe 23 and is discharged into the environment preferably via one or a plurality of mufflers (not shown).

The conversion capability of the oxidation catalytic converter 29 decreases over time due to the effects of aging. In order to assure a low-emission operation of the internal combustion engine 11, the control unit 17 regularly checks to determine whether the oxidation catalytic converter 29 is still in a sufficiently good working order. If the check finds the oxidation catalytic converter 29 no longer to be in a sufficiently good working order, the control unit 17 can carry out an appropriate action. For example, it can relay this error within a motor vehicle, in which the internal combustion engine is installed, so that the error can be indicated to the driver. Moreover, the error can also be recorded in an error memory, which, for example, is present in the control unit 17, so that a lack of operability of the oxidation catalytic converter 29 can be reported when the motor vehicle is next serviced.

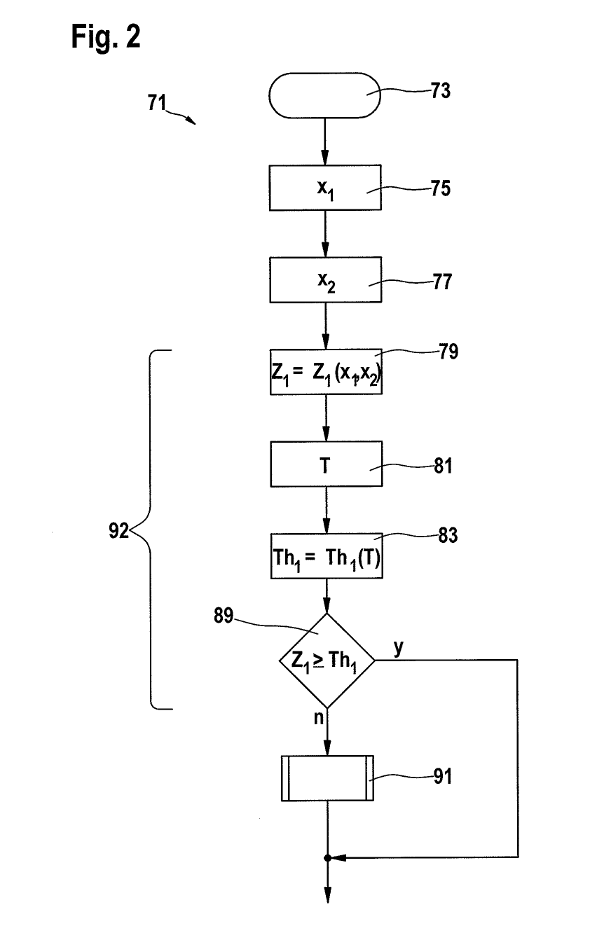

FIG. 2 shows a flow diagram of a first embodiment of a method 71 for checking the operability of the oxidations catalytic converter 29. After start-up 73 of the method 71, the first sensor variable x₁ generated by the first HC sensor 45, which characterizes a concentration of the hydrocarbons in the inflowing exhaust gas 43, is acquired by the control unit 17 in step 75. The control unit 17 subsequently in step 77 acquires the sensor variable x₂ generated by the second HC sensor 51, which characterizes the concentration of hydrocarbons in the exhaust gas 49 flowing out of the oxidation catalytic converter 29. After both of the sensor variables x₁ and x₂ have been acquired, the control unit 17 calculates a first variable Z₁ in step 79, which characterizes a reaction rate of an oxidation of the hydrocarbons taking place in the oxidation catalytic converter 29. The first variable Z₁ is therefore a measurement for the conversion of hydrocarbons taking place in the oxidation catalytic converter 29. In one embodiment, the variable Z₁ is ascertained by subtracting the two sensor variables x₁ and x₂ from each other, for example by means of a calculation: Z₁=x₁−x₂. The control unit 17 subsequently executes step 81, wherein the exhaust gas temperature T is acquired by means of the temperature sensor 55. By way of derogation, provision can be made for the exhaust gas temperature T to be calculated by means of an empirical and/or physical model of the internal combustion engine 11, which can be deposited in the control unit 17. In this case, the temperature sensor 55 can be omitted.

A reliable range for the first variable Z₁ is subsequently ascertained as a function of the exhaust gas temperature T. In the embodiment shown, the range is specified (Step 83) by a first threshold value Th₁ as a range open to the top on one side. By specifying 83 the first threshold value Th₁ as a function of temperature, the temperature dependant behavior of the oxidation catalytic converter 29 is taken into account.

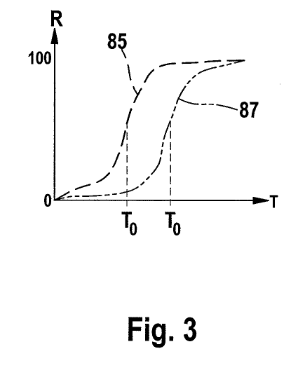

In FIG. 3 this temperature dependence of the reaction rate R on the exhaust gas temperature T is depicted. The reaction rate R is stated as a percentage in this case. A value of 100% corresponds to a complete oxidation of the hydrocarbons contained in the inflowing exhaust gas 43. The reaction rate R corresponds to a conversion of the hydrocarbons in the oxidation catalytic converter 29 with respect to a unit of time. The reaction rate R of the new, fully operable oxidation catalytic converter 29 is depicted as a first curve 85. A second curve 87 shows the reaction rate R of the aged oxidation catalytic converter 29, which is no longer in a sufficiently good working order. In addition light-off temperatures T₀ of the oxidation catalytic converter 29 are marked in the diagram shown in FIG. 3. By the light-off temperature T₀, that exhaust gas temperature T is understood here, from which the oxidation catalytic converter 29 is capable of oxidizing 50% of the hydrocarbons flowing into it. It is apparent from the diagram that the light-off temperature increases on account of the ageing of, respectively the wear to, the oxidation catalytic converter 29. The aged oxidation catalytic converter 29 is consequently only effective for relatively high exhaust gas temperatures T>Tₒ. In step 83 the method 71 preferably selects such a first threshold value Th₁, which characterizes a reaction rate R, which for the exhaust gas temperature T acquired in step 81 is smaller than or equal to a value specified by the first curve 85. In particular a value can be selected, which lies between the two curves 85, 87.

The control unit 17 subsequently compares the first variable Z₁ with the first threshold value Th₁ in a branch 89 of the method 71. If the first variable Z₁ is larger than or equal to the first threshold value Th₁, the method 71 is then (Y) concluded. Otherwise (N) an error processing routine 91 is executed before the method 71 is concluded. During the error processing routine 91, the error can be recorded in an error memory of the control unit 17 and/or the error can be indicated to the driver of the motor vehicle.

Steps 79, 81, 83 and 89 constitute a comparison operation 92 for comparing the two sensor variables x₁ and x₂ with each other. Said operation 92 works as a function of the exhaust gas temperature T in the embodiment shown; it can, however, also work independently of the exhaust gas temperature T in other embodiments.

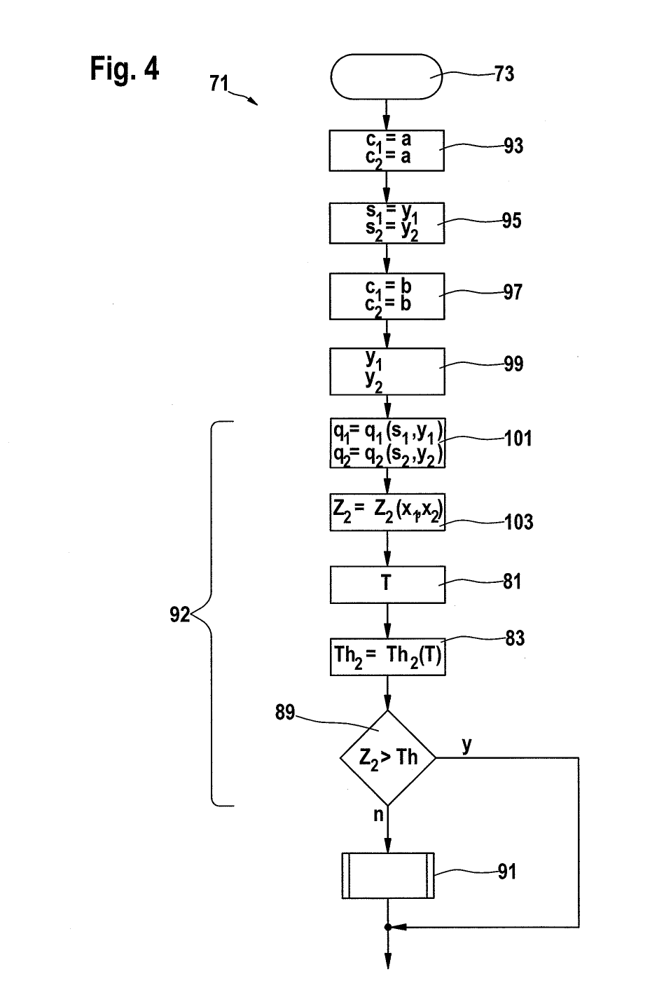

FIG. 4 shows a second embodiment of the method 71. This embodiment is based on a ratio being ascertained in each case between a concentration of the nitrogen dioxide (NO₂) and a concentration of all of the nitrogen oxides (NOₓ) for the inflowing exhaust gas 43 and for the outflowing exhaust gas 49. If a difference between this ratio during inflow of the exhaust gas 43 and this ratio during outflow of the exhaust gas 49 is too small, an oxidation catalytic converter 29, which is not in good working order, is then suggested.

After the start-up 73 of the method, the two switchable mixed potential sensors 47, 53 are adjusted in such a way in step 93 that they have an especially high sensitivity for NO₂. To achieve this, the control unit 17 applies a first control value a as the first control variable c₁, respectively as the second control variable c₂, to the two switchable mixed potential sensors 47, 53.

The control unit 17 subsequently acquires the two sensor variables y₁ and y₂, which characterize the concentration of the NO₂ in the inflowing exhaust gas 43, respectively in the outgoing exhaust gas 49, and deposits said variables y₁ and y₂ as intermediate values s₁, respectively s₂.

In step 97 of the method, which follows step 95, the control unit 17 applies a second control value b for the two control variables c₁ and c₂ in order to adjust the two mixed potential sensors 47, 53 in such a way that they have an especially high sensitivity for nitrogen monoxide. Afterwards the control unit 17 acquires the two sensor variables y₁ and y₂, which henceforth characterize the concentration of nitrogen monoxide in the inflowing exhaust gas 43, respectively in the outflowing exhaust gas 49 (step 99).

A first parameter q₁ for the inflowing exhaust gas 43 as a function of the first intermediate value s₁ and the sensor signal y₁ acquired in step 99 and a second parameter q₂ for the outflowing exhaust gas 49 as a function of the second intermediate value s₂ and the sensor variable y₂ acquired in step 99 are subsequently calculated in step 101. In so doing, the first parameter q₁ characterizes the ratio between the concentration of the NO₂ and the concentration of all of the nitrogen oxides in the inflowing exhaust gas 43, and the second parameter q₂ characterizes this ratio for the outflowing exhaust gas 49.

A second variable Z₂, which characterizes a change in this ratio due to the oxidation catalytic converter 29, i.e. characterizing a difference between the ratios between NO₂ and the nitrogen oxides, is subsequently calculated as a function of the two parameters q₁ and q₂ preferably by subtracting these parameters from each other (step 103).

The following steps 81, 83, 89 and 91 essentially correspond to the steps, which are denoted with the same reference numerals, of the first embodiment of the method shown in FIG. 2; however, in step 89 the first threshold value Th₁ is not compared with the first variable Z₁ but a second threshold value Th₂ is compared with the second variable Z₂. In the second embodiment, the comparative operation 92 comprises the steps 101, 103, 81, 83, and 89, wherein the sensor variables y₁ and y₂ are this time compared with each other. Provision can also be made in the second form of embodiment for the comparative operation to work independently of the exhaust gas temperature T.

The fact that a chemical equilibrium between the nitrogen monoxide and the nitrogen dioxide with respect to the reaction

2NO+O₂=2NO₂

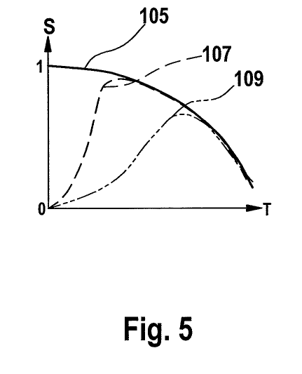

depends on the exhaust gas temperature T, respectively a temperature of the oxidation catalytic converter 29, can be taken into account when ascertaining the second threshold value Th₂. This correlation is depicted in FIG. 5. The exhaust gas temperature T is plotted on the x-axis of the diagram shown in FIG. 5, and a percentage S of the NO₂ of the nitrogen oxides in the outflowing exhaust gas 49 is plotted on the y-axis. A third curve 105 indicates the values of the percentage S and the exhaust gas temperature T, whereat the chemical equilibrium is present. A fourth curve 107 shows the percentage S in the outflowing exhaust gas for the new, fully operative oxidation catalytic converter, whereas a fifth curve 109 shows the percentage S for the aged oxidation catalytic converter 29, which is no longer sufficiently in good working order. In the case of the aged oxidation catalytic converter 29, a percentage S corresponding to the chemical equilibrium 105 is first achieved at a relatively high exhaust gas temperature T.

When executing the method 71 according to the second embodiment, the second threshold value Th₂ is preferably selected in such a way that it corresponds to a percentage S, which lies below the fourth curve 107, preferably between the fourth curve 107 and the fifth curve 109.

The state of the chemical equilibrium represented by the third curve 105 in FIG. 5 is primarily determined by the exhaust gas temperature T and an oxygen concentration in the exhaust gas. If a concentration of nitrogen dioxide (NO₂), which lies in chemical equilibrium (third curve 105), is measured in the exhaust gas 49 flowing out of the oxidation catalytic converter 29 by, for example, a second mixed potential sensor 53, the temperature of the oxidation catalytic converter 29 and/or the exhaust gas temperature T can be directly suggested if a degree of ageing of the oxidation catalytic converter 29 is known as well as the oxygen concentration in the exhaust gas. The oxygen concentration can be acquired by means of a sensor.

The method 71 can be regularly repeatedly executed so that the oxidation catalytic converter 29 can be continuously monitored. The method 71 can then always be started if the internal combustion engine 11 is situated in a steady-state operating condition, for example during idle. The two embodiments of the method 71 can be combined with each other. The corresponding variations of the method can, for example, be executed consecutively or concurrently.

As a whole the method according to the invention provides a possibility for checking the oxidation catalytic converter 29, which has in comparison to other catalytic converters used in motor vehicles relatively small storage effects, in particular a very small oxygen storage capability. The oxygen storage capability of the oxidation catalytic converter 29 lies, for example, only at 1/10 to at most ⅕ of the oxygen storage capability of a three-way catalytic converter.

1. Method for checking the operability of an oxidation catalytic converter, through which exhaust gas of an internal combustion engine flows, wherein a first sensor variable (x₁, y₁), which characterizes a composition of the exhaust gas flowing into the oxidation catalytic converter, and a second sensor variable (x₂, y₂), which characterizes a composition of the exhaust gas flowing out of the oxidation catalytic converter, are acquired, wherein the first sensor variable (x₁, y₁) is acquired by means of at least one first mixed potential sensor disposed in a direction of flow of the exhaust gas upstream of the oxidation catalytic converter, and the second sensor variable (x₂, y₂) is acquired by means of at least one second mixed potential sensor disposed in the direction of flow of the exhaust gas downstream of the oxidation catalytic converter; and in that the operability of the oxidation catalytic converter is checked by comparing the first sensor variable (x₁, y₁) with the second sensor variable (x₂, y₂).

2. The method according to claim 1, wherein the first sensor variable (x₁, y₁) characterizes a concentration of hydrocarbons contained in the exhaust gas flowing into the oxidation catalytic converter, and the second sensor variable (x₂, y₂) comprises a concentration of hydrocarbons contained in the exhaust gas flowing out of the oxidation catalytic converter.

3. The method according to claim 2, wherein a first variable (Z₁), which characterizes a reaction rate of an oxidation of the hydrocarbons taking place in the oxidation catalytic converter, is ascertained when comparing the two sensor variables (x₁, x₂) with each other, and in that the oxidation catalytic converter is recognized to be in good working order if the first variable (Z₁) lies in a predetermined first range, preferably if the first variable (Z₁) is at least as large as a predetermined first threshold value (Th₁).

4. The method according to claim 1, wherein the first sensor variable (y₁) characterizes a concentration of nitrogen dioxide, a concentration of nitrogen oxides or a percentage of the nitrogen dioxide to the nitrogen oxides in the exhaust gas flowing into the oxidation catalytic converter and/or in that the second sensor variable (y₂) comprises a concentration of nitrogen dioxide, a concentration of nitrogen oxides or a percentage of the nitrogen dioxide to the nitrogen oxides in the exhaust gas flowing out of the oxidation catalytic converter.

5. The method according to claim 4, wherein a second variable (Z₂), which characterizes a change in the percentage of the nitrogen dioxide to the nitrogen oxides due to the oxidation catalytic converter, is ascertained when comparing the two sensor variables (y₁, y₂) with each other; and in that the oxidation catalytic converter is recognized to be in good working order if the second variable (Z₂) lies within a predetermined second range, preferably if the second variable is at least as large as a predetermined second threshold value (Th₂).

6. The method according to claim 1, wherein the first mixed potential sensor and/or the second mixed potential sensor are activated for influencing a sensitivity of the same with respect to hydrocarbons, the nitrogen dioxide, the nitrogen oxides and/or with respect to the percentage of the nitrogen dioxide to the nitrogen oxides.

7. The method according to claim 1, wherein an exhaust gas temperature of the exhaust gas flowing into the oxidation catalytic converter and/or of the exhaust gas flowing out of the oxidation catalytic converter is ascertained or acquired, and in that the operability of the oxidation catalytic converter is checked as a function of the exhaust gas temperature.

8. The method according to claim 7, wherein the first range, respectively the first threshold value (Th₁) and/or the second range, respectively the second threshold value (Th₂) are specified as a function of the exhaust gas temperature.

9. Control unit for the open-loop and/or closed-loop control of an internal combustion engine fitted with an oxidation catalytic converter, through which exhaust gas of the internal combustion engine flows, the control unit being equipped for checking the operability of the oxidation catalytic converter as well as for acquiring a first sensor variable (x₁, y₁), which characterizes a composition of the exhaust gas flowing into the oxidation catalytic converter, and a second sensor variable (x₂, y₂), which comprises a composition of the exhaust gas flowing out of the oxidation catalytic converter, wherein the control unit is equipped, preferably is programmed: for acquiring the first sensor variable (x₁, y₁) by means of at least one first mixed potential sensor disposed in a direction of flow of the exhaust gas upstream of the oxidation catalytic converter, for acquiring the second sensor variable (x₂, y₂) by means of at least one second mixed potential sensor disposed in the direction of flow of the exhaust gas downstream of the oxidation catalytic converter and for checking the operability of the oxidation catalytic converter by comparing the first sensor variable (x₁, y₁) with the second sensor variable (x₂, y₂).

10. The control unit according to claim 9, wherein said unit relates to a mixed potential sensor for hydrocarbons and/or a mixed potential sensor for nitrogen oxides with regard to the first mixed potential sensor and/or the second mixed potential sensor.
